(19) United States
(12) Patent Application Publication
(10) Pub. No.: US 2024/0162721 A1
(43) Pub. Date: May 16, 2024

(54) SYSTEM AND METHOD FOR USING MULTIPLE HIGH VOLTAGE BATTERY PACKS IN PARALLEL

(71) Applicant: EMATRIX ENERGY SYSTEMS, INC., Southfield, MI (US)

(72) Inventor: Matthew GRIFFITH, Southfield, MI (US)

(21) Appl. No.: 18/550,030

(22) PCT Filed: Mar. 9, 2022
(86) PCT No.: PCT/US2022/019542

§ 371 Date: Sep. 11, 2023

Related U.S. Application Data
(60) Provisional application No. 63/158,877, filed on Mar. 9, 2021.

(51) Int. Cl. H02J 7/00; H01M 10/42; H01M 10/48

(52) U.S. Cl. CPC H02J 7/00041; H01M 10/425; H01M 10/486; H02J 7/0019; H02J 7/0049; H02J 7/007182; H01M 2010/4271; H01M 2010/4278

(57) ABSTRACT

An energy management system comprising a parallel storage pack comprising a first battery pack and a second battery pack. The first and second battery packs can be connected in parallel and both be communicatively connected to a control system. The control system can provide a measurements or estimates of one or more of the following: the state of charge (“SOC”), current limit, and resistance of each of the battery packs. The control system can the be configured to determine the current limit of the parallel battery packs and entire battery pack system. Based upon the measurements the system can allow for each of the battery packs to fully utilizing the energy available in battery packs of the energy system as well as more efficiently charge the battery packs of the energy system.

### CROSS-REFERENCE

This U.S. Patent application claims priority to U.S. Provisional Application 63/158,877 filed Mar. 9, 2021, the disclosure of which is considered part of the disclosure of this application and is hereby incorporated by reference in its entirety.

### FIELD OF THE INVENTION

This invention relates generally to battery and control systems for battery packs. In one aspect, the present disclosure relates to a system and method for battery packs connected in parallel.

### BACKGROUND

Batteries are a convenient source of electrical energy for many types of portable and/or mobile electronics. A typical battery is formed by the connection of a number of electrical cells connected in a series configuration. Many types of batteries include rechargeable cells, such that when an outside energy source is applied to the battery cells energy is stored within the cells. While many chemical combinations for the cathode and the anode of the battery cells exist, some commonly used combinations include nickel cadmium (NiCd), nickel metal hydride (NiMH), and lithium ion (Li-Ion) compositions.

Rechargeable battery cells can provide a convenient source of energy, however, rechargeable battery cells do not have an infinite life span and the ability of the cells to hold a charge degrades over the lifetime of the cell. Periods of non-use may occur while the cells are being held by a manufacturer before the cells are assembled into a battery, or while the cells are assembled into the battery, but the battery has not yet been sold, or during long periods of non-use of the battery by the consumer. Furthermore, due to the internal resistance of the battery, battery cells may not discharge evenly within the battery. All of these factors cause each battery cell to hold a different level of charge in comparison to the other cells in the battery. These different levels of charge can result in unpredictable indications of low battery, possible inadvertent energy shutdowns, and affect battery efficiency and performance. Similarly, present technology would either not allow the use of unbalanced batteries without servicing the system and balancing them externally. Current technology also assumes that the current is shared evenly between batteries which could cause excess current draw in one of the batteries.

Energy storage systems that include a configuration of a plurality of battery packs made up of battery cells that are arranged in parallel have the potential for a high pack to pack balancing current, that may flow to charge battery packs and cause damage to one or more of the battery packs. As a result, the current generated by voltage differences among the battery packs, and the heat that is generated due to the flow of current in the battery pack configuration must be managed. Currently, when multiple unbalanced battery packs are connected in parallel there will be a balancing current that flows between them regardless of any external loads. Each battery pack in parallel will have a unique current limit based on its state of charge and internal resistance, but the device using the energy storage system can only control the current at the node where all the batteries are connected, so it is difficult to ensure that the individual current limits are met for each battery. When battery packs are connected in parallel using contactors current will flow through a contactor when it is closed. The larger the current the more it can degrade the life of the contactor.

There exists a need to provide a method and energy storage system to accurately monitor and efficiently control battery charge to ensure that a device utilizing the battery packs are capable of fully utilizing the energy available in the battery system and/or more efficiently charge the battery pack system. Furthermore, there exists a need for an energy storage system that allows for battery pack operation by connecting as many battery packs as possible in parallel without damaging contactors or negatively impacting vehicle performance.

### BRIEF SUMMARY OF THE INVENTION

In one aspect, this disclosure is related to an energy storage system comprising a parallel storage pack comprising a first battery pack and a second battery pack. The first and second battery packs can be connected in parallel and both be communicatively connected to a control system. The control system can provide an estimate of one or more of the following: the state of charge (“SOC”), current limit, and resistance of each of the battery packs. The control system can then be configured to determine the current limit of the parallel pack. The current limit for each pack is calculated to ensure that the limits for each pack are measured.

In another aspect, this disclosure is related to a method of determining the current limit of a parallel pack having a first battery pack and secondary battery pack connected in parallel by measuring the SOC and resistance of each battery pack.

In yet another aspect, the present disclosure can relate to an energy management system that can include a plurality of battery packs. In some exemplary embodiments, the system can include first battery pack having one or more battery cells and a second battery pack having one or more battery cells, wherein the first battery pack and the second battery pack can be connected in parallel. The system can further include a first battery pack controller communicatively that can be coupled to the first battery pack and second battery pack controller that can be communicatively coupled to the second battery pack. The first and second controllers can each include a processing means. Additionally, each of the first battery pack controller and second battery pack controller can be communicatively coupled to a voltage sensor, a current senor, or battery temperature sensor for each of the respective battery packs. A master controller comprising a transceiver, a processing means 601 and a memory 603 can further be communicatively coupled to each of the battery pack controllers. In some embodiments, the master controller, first battery pack controller, or second battery pack controllers can determine the battery current (I), estimated internal resistance (Rint), terminal voltage (Vt), instantaneous current, charge current limit (IClim) and the discharge current limit (IDlim) for each of the battery packs. Additionally, the master controller or battery pack controllers can further determine the change in terminal voltage (ΔVt) and change in open circuit voltage (ΔOCV). Based upon these measurements, the master controller or one or more of the battery pack controllers can determine when to open or close the respective battery pack contactors for a charging cycle or discharging cycle of the energy management system.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a block diagram showing the configuration of an exemplary embodiment of an energy management system of the present disclosure.

FIG. 2 is a diagram of configuration an exemplary embodiment of the energy management system of an exemplary embodiment of the present disclosure having multiple battery packs.

FIG. 3 is a flow diagram of a startup process of an exemplary embodiment of the energy storage system of the present disclosure.

FIG. 4 is a flow diagram of the energy management system of and exemplary embodiment of the present disclosure.

FIG. 5 is a flow diagram for determining current limits of an exemplary embodiment of the energy managements system of the present disclosure.

FIG. 6 is a block diagram showing components of a master controller or a battery pack controller of an exemplary embodiment of an energy management system of the present disclosure.

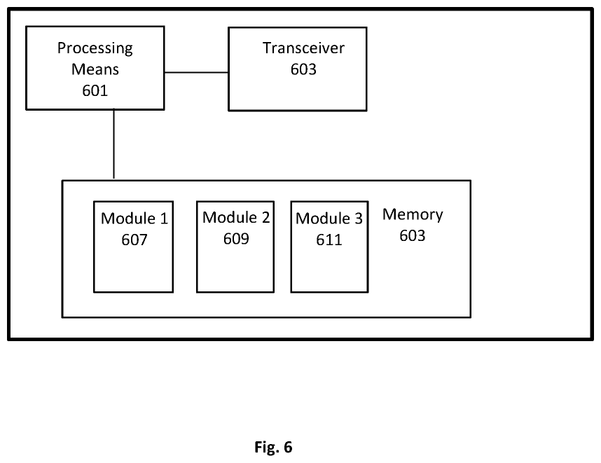

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

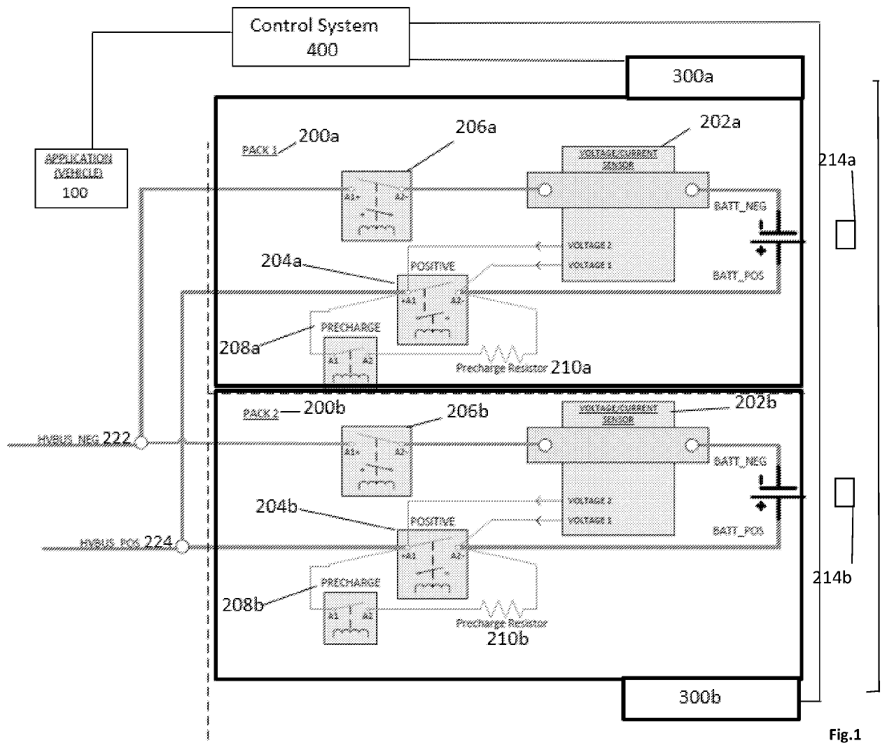

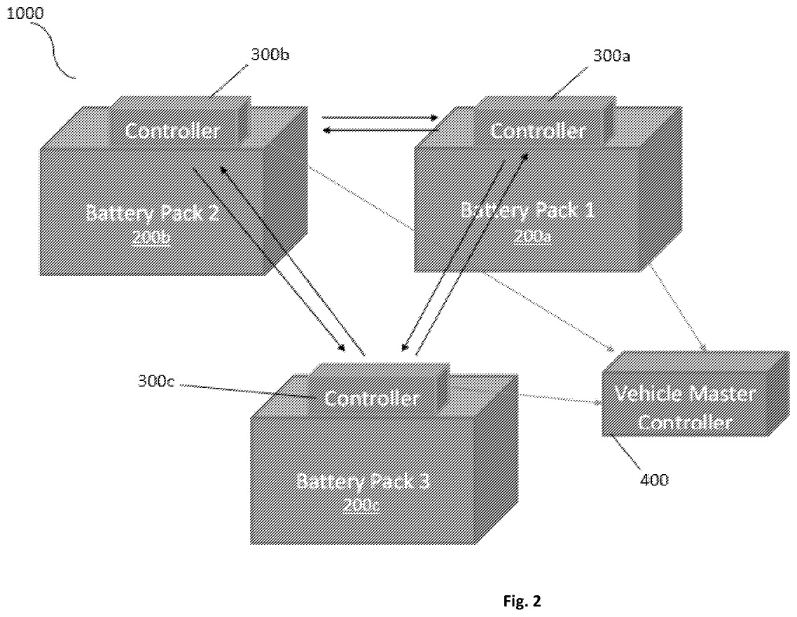

As shown in FIGS. 1-2, the present disclosure relates to an energy storage system that can include a first battery pack 200a and a second battery pack 200b, wherein the one or more battery packs can be communicatively coupled to a vehicle or other device 100. In some exemplary embodiments, the present disclosure relates to a vehicle utilizing the energy storage system of the present disclosure. In some exemplary embodiments, the system can include a multitude of battery packs 200 connected in parallel. The energy system can include a first energy storage pack 200a that can include on ore more battery cells and a second battery pack 200b that can include one or more battery cells. The first and second energy storage packs 200 can be connected in parallel. Each battery pack can further include a controller 300 communicatively coupled to the battery pack. Additional, battery packs can be included, as shown in FIG. 2 wherein the system can further comprise a third battery pack 200c and controller 300c. In some exemplary embodiments, the system can include a battery detector and current/voltage sensor communicatively coupled to the corresponding controller 300. It is understood that the number of packs in parallel can be unlimited and is not restricted to just three battery packs.

An exemplary embodiment of the energy management system can further be communicatively coupled to a vehicle/device master controller 400. The one or more corresponding controllers 300 to the battery packs can be communicatively coupled to a master controller 400. Similarly, each of the individual controllers 300 can be communicatively coupled to one another. A user can connect the system to a charging station in order to charge one or more battery packs. The control system 400 can sense when it has been coupled to a charging station. The system controller 400 and/or one or the battery pack controllers 300 can be communicatively coupled to a charging port, which can be communicatively coupled to a charging source. In some exemplary embodiments, the system controller 400 can be communicatively coupled to the one or more controllers 300 can be used to identify the voltage level of each of the battery packs 200. In some exemplary embodiments, the system controller 400 can determine which pack has the highest charge remaining. Alternatively, in other embodiments that without a master controller 400, one of the pack controllers 300 can be determined or designated to be the master controller of the system. The master controller can then allow each battery pack to charge to the capacity of the highest charged battery pack. They system can then charge the remaining battery packs in parallel together until the battery packs are fully charged.

FIG. 1 provides an illustration of an exemplary embodiment of a control/management system of the present disclosure can include one or more battery pack voltage/current sensors 202. The voltage/current sensors can either be a single or individual sensors. As shown, FIG. 1 provides an illustration having a first battery pack module 200a and a second battery pack module 200b. It should be understood that the present disclosure can utilize multiple battery packs as necessary for each system and application. Each battery pack module 200 can include a controller 300, one or more battery cells, one or more voltage/current sensors 202, one or more battery cell temperature sensors 214, one or more switches/contactors 204 on the positive side and one or more switches/contractors 206 on the negative side. In some exemplary embodiment, the battery back will only use a single switch/contactor. The battery packs can optionally include a pre-charge switch 208 and a pre-charge transistor 210. The battery system can be coupled to the device 100 utilizing one or more busbars. The device 100 can have a HVBUS negative terminal 222 and an HVBUS positive terminal 224. The negative terminal 222 can be communicatively couped to the discharge switches 206 and the positive terminal can be communicatively coupled to the charge switches 204. The voltage/current sensor 202 can measure the voltage and/or current at one or more points in the battery pack include a voltage (Voltage 2) prior to the charge switch (Position A1) and voltage (Voltage 1) after the charge switch (Position A2) for each of the battery packs of the battery/energy storage system.

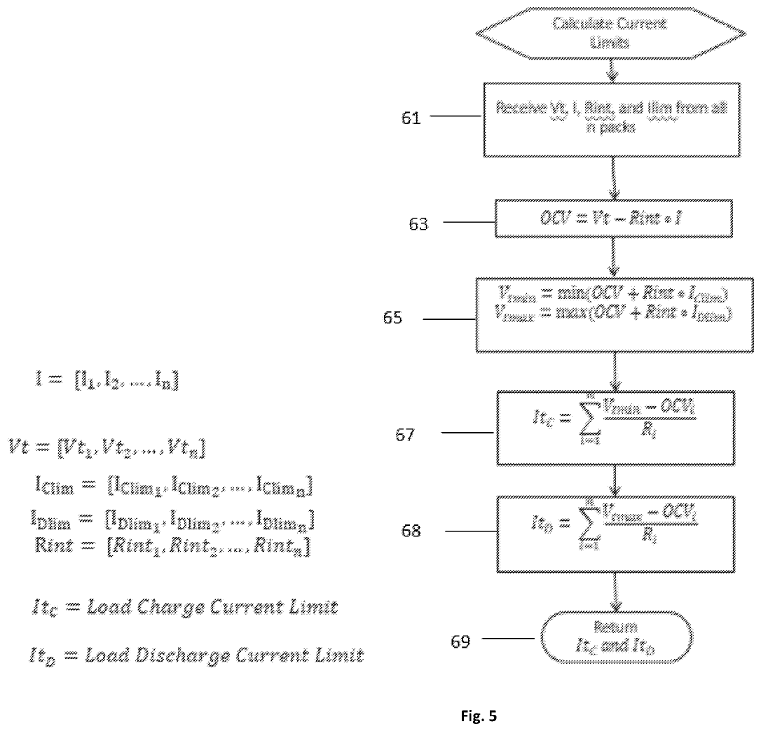

The contactors/switches 204, 206 can be closed to use the prescribed battery pack(s) communicated from master controller 400 and/or one ore more of battery pack controllers 300. In some exemplary embodiments, the individual pack controllers 300 can be communicatively coupled to each other as shown in FIG. 2. One or more of the single pack controllers can transmit communications back to the master controller 400 with information for the single battery pack and/or all of the battery packs of the system. Similarly, a single pack controller 300 can provide all battery pack information for all battery packs of the master controller 400 and/or or the other battery pack controllers 300. The information provided can provide the available energy for each individual pack 200 or for the packs connected collectively together. Each pack controller 300 can report the minimum voltage of each pack 200, which in turn provides the total minimum voltage of the system. Similarly, the additional information can be average voltage, max voltage, current, etc. A consolidated system level current limit can be calculated and provided to the master controller/control system 400 as shown in FIG. 5.

The master control system 400 and each pack controller 300 can further include a microprocessor having random access memory, read only memory, input ports, real time clock, output ports, and a controller area network (CAN) port for communicating to systems outside of the battery pack as well as to communicatively couple monitoring devices and other battery pack modules. In some exemplary embodiments, the master control system 400 can be a part of the device coupled to the battery packs. In some exemplary embodiments, the master controller 400 can be incorporated into or a part of a device or vehicle system 100. The master controller and the pack controllers can additionally include transceivers 605 to receive and transmit information to each other. In other exemplary embodiments, the master controller can be communicatively coupled to each of the battery packs and collect the data directly and operate as a battery pack controller to allow for each of the packs to be communicatively coupled.

The master controller 400 and/or the individual battery pack controllers 300 can monitor, measure and/or calculate the measured battery current (I), estimated internal resistance (Rint), and the terminal voltage (Vt) of each of the battery packs 200. Additionally, temperature and other environmental measurements can be monitored and measured of the battery packs 200. The battery pack measurements can further include the instantaneous current, charge current limit (I chm) and the discharge current limit (I N A. The Vt can be the voltage measured between a battery packs positive and negative terminals. The open circuit voltage (OCV) can be calculated utilizing the Vt, I, and Rint.

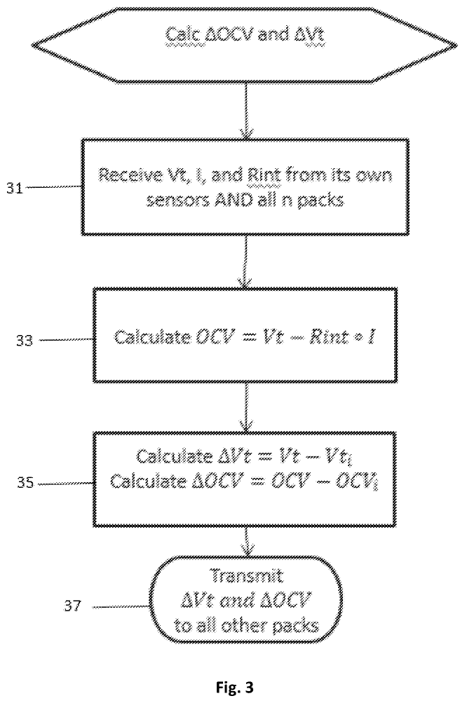

As shown in FIG. 3, the change in OCV (ΔOCV) and the change in terminal voltage (ΔVt) to be determined for each individual battery back of the system. The Rint, Vt, and I can be measured or received from the corresponding sensor on all battery packs 200 (Step 31). The measurements can be communicated to the battery pack controller 300. The OCV can be calculated utilizing the below formula (Step 33). The change in terminal voltage and change in open circuit voltage can then be calculated by subtracting the initial measurement from the existing measurement (Step 35). After the ΔOCV and ΔVt have been calculated the measurements can be transmitted to all other battery module/packs 200 and/or controllers 300 (Step 37).

OCV=Vt×Rint*I Formula 1:

In some exemplary embodiments, the controller 400 and/or one or more pack controllers 300 can monitor the voltage between one or more battery packs 200. If the voltage difference between the battery packs is too high to allow for the battery pack to be connected in parallel, the battery pack controller 300 can then allow for a connection of the higher voltage battery pack 200 if the system will be discharging. Alternatively, if the system will be charging, the system can allow the lower voltage pack to be connected. This can be applied to multiple packs 200 connected in parallel. Each battery pack 200 can include one or more battery cells connected together in an enclosure with contactors and a controller. Each pack controller 300 can communicate with additional pack controllers 300 through any suitable means and be aware of the voltages and values of the other packs 200. The pack controllers 300 can determine if its value is the lowest or highest pack in the battery pack system 1000 to determine whether to close or open its contactor 204, 206 for charging and discharging optimization.

For a discharge cycle, the master control system 400 can signal intent to discharge run a charge or discharge program/cycle. The pack controllers 300 can communicate and run a monitoring cycle to determine the battery pack with the highest or lowest state of charge (“SOC”) to be used and designated as the primary battery pack 200 for a charge or discharge cycle. The primary battery pack contactor(s) can be closed first and can communicate to the remaining battery packs for the remaining battery packs to compare and determine when their respective voltages match/equal the primary pack's current voltage measurement. When one or more additional battery packs matches the voltage or is within a predetermine threshold range of the primary pack, the respective battery pack may similarly close its contactors to discharge or charge the battery pack along with the primary pack. The battery pack controllers 300 can monitor the voltage measurements of the primary battery pack while it is charging or discharging and can determine when the initial primary battery pack reaches a voltage threshold to allow for the one or more additional battery packs to the close its contactor and initiate discharge of the one or more secondary battery packs. This battery system allows the various battery packs 200 to optimally charge and discharge thereby maximizing the efficiency of the battery pack system.

Additionally, in some exemplary embodiments, the control system 400 and/or individual pack controllers 300 can be used to monitor condition of one or more battery packs 200, wherein the battery packs 200 are connected in parallel. The control system 400 can monitor the battery packs 200 utilizing the one or more current/voltage sensors and collect the SOC and internal resistance for each battery pack 200 of the energy storage system 1000. The master control system 400 can be communicatively coupled to each battery pack 200 and the battery pack controller 300. The battery pack controllers 300 can be communicatively coupled to current/voltage sensors 202.

In some exemplary embodiments, the entire battery pack 200 can have a single current and/or voltage sensor 202. In other exemplary embodiments, each battery cell of the battery pack can have a voltage and/or current sensor. In such exemplary embodiments, a controller 300 can be communicatively coupled to each battery cells of the battery pack 200 and can measure and/or monitor the individual battery cells. In some exemplary embodiments a memory can store one or more program modules. A first program module/algorithm 607 can be initiated by the control system 400 and/or one or more of the battery pack controllers 300 to measure the SOC of each of the battery packs 200 connected in parallel of the battery system 1000. If the measured SOC between one or more battery packs 200 exceeds a predetermined threshold current draw amount during close of a contactor, then the control system 400 or a battery pack controller 300 can prevent the connection between the busbar and the one or more battery packs 200 during a discharge operation.

Similarly, a second program module 609 can be initiated for the charging/discharging of the one or more battery packs 200. During a charging operation the control system 400 can initiate a first program module 607 to first measure and identify the battery pack 200 having the lowest voltage. The control system 400 can then connect the battery pack 200 having the lowest measured voltage first to the busbar. The subsequent battery packs 200 can then be connected as long as a contactor current is below a pre-determined threshold determined by a third program module 611 for monitoring/calculating the current limit of the battery system 1000. When the energy storage system 1000 of the present disclosure is discharging, the battery having the highest voltage can be connected first. Furthermore, the system can use the current limit measurements for battery packs 200 on one or more of the packs to determine the most efficient charging and discharging operation of the battery packs 200.

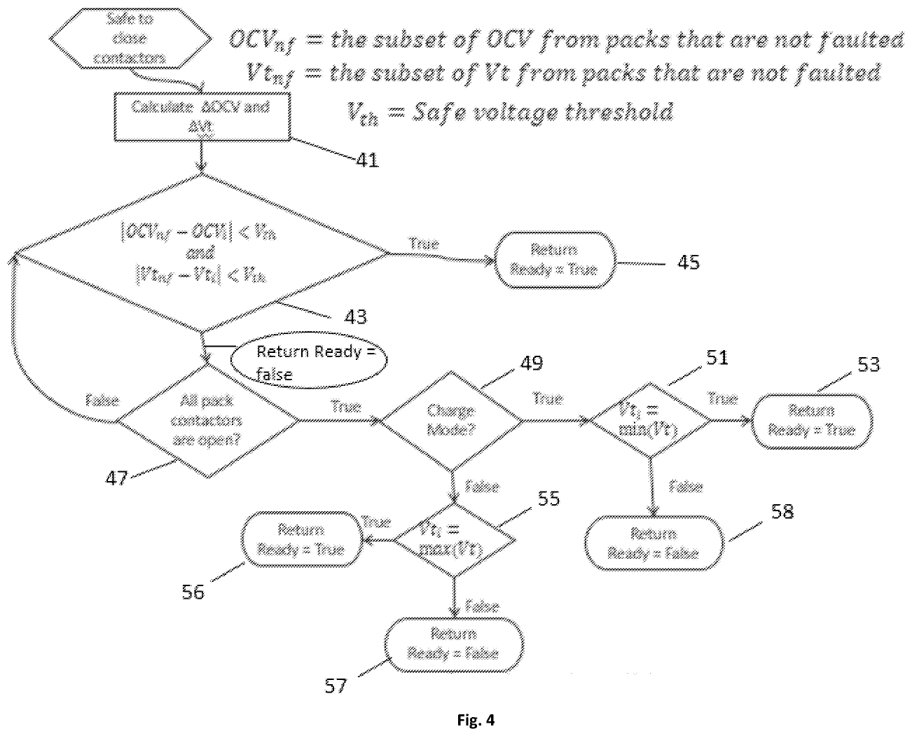

As shown in FIG. 4, the master controller 400 or device can initiate a startup algorithm/process to provide for safer and more efficient utilization in the charging and discharging of multiple battery packs 200 communicatively coupled to a device. The system can determine when to open or close contactors based upon the measurements of one or more measurements, including but not limited to the ΔOCV and/or ΔVt (Step 41). In one exemplary embodiment, when the difference between the OCV of battery packs that are not faulted (OCV_{nf}) and the initial OCV (OCVᵢ) for each individual battery packs is less than the safe voltage threshold (Vₜₕ) and the terminal voltage from packs that are not faulted (Vt n f) and the initial terminal voltage (Vtᵢ) for each individual battery packs the system will return a response to a user that the system is ready (Step 45) for either a charge or discharge cycle and return which battery pack will be established as the primary battery pack. If one or both of the measurements is greater than the Vₜₕ, then one or more contactors can be open. If all contactors are not open, then the system can proceed to a charge/discharge mode determination, however, if all the contactors are not open then the system will maintain contactors closed until the values above are obtained (Step 47).

If a battery pack malfunctions or become unusable, the remaining pack controllers communicate with battery packs to determine primary battery pack upon startup. Similarly, the system can monitor for fault detection and will not initiate the startup algorithm to include battery packs containing faults. Any fault detected packs will not be able to close contactors even if highest voltage available of all of the battery packs. The OVCi value can be determined for each individual battery pack (i.e., battery pack 1, battery pack 2, etc.). If a battery pack is faulted the system will not allow for it to run through the startup algorithm of FIG. 4. Step 43 can be a continuous monitored and measured for each battery pack during a charge/discharge cycle and similarly can be used to establish a peak or minimum voltage value among the battery packs to establish a primary battery pack.

The battery controllers can communicatively determine which battery pack has the peak voltage value and assign it as the primary battery pack. The primary battery pack can then close its contactor(s) to allow for discharge or charging respectively. The remaining battery packs can continuously compare their voltage values against established primary battery pack and the primary battery packs voltage measurements as it is charging or discharging. When one ore more additional battery pack meets the voltage threshold of the primary pack, the pack controller 300 can return a ready signal to initiate the contactor and start discharging or charging the next battery pack 200. In some instances, more than one battery pack can be initiated to be charged or discharged with the primary pack if the one or more battery packs reach the voltage of the primary battery pack, as the battery pack contactors are continuously closed for discharging or charging.

In some exemplary embodiments, battery packs may be initially connected together for a period of time but may be disconnected if the controller determines that the two or more battery packs create a voltage or current issue or detect a fault within the system. As shown at step 43 of FIG. 4, if the system determines the return ready is false (Step 44) the system can open or close the contactors of one or more battery packs depending upon voltage. For instance, battery packs of various sizes or capacities may be initially connected but later disconnected depending upon voltage or current measurements.

Furthermore, an exemplary embodiment of the present disclosure can calculate one or more current limits of each of the individual battery packs and/or of the battery pack system in its totality. The master controller 400 and/or pack controllers 300 can first measure or receive then the system and initiated a charge or discharge mode/program (Step 49). If the system is in a Charge Mode, the min (Vt) value will be established to determine the primary pack of the battery system. As each battery pack reaches the Vtᵢ=min (Vt) then the system will return that the battery packs is ready to be charged and/or balanced with the packs charging, such as the primary battery pack and any subsequent battery packs being charged. If the Vt, (is not equal to min (Vt) then the system will provide an indicator to a user and/or controller 400 that the battery packs of the system are not ready to be connected for charging and/or is not balanced (Step 58). Similarly, if the system is not in a discharge mode and the Vti=max (Vt) then the system will return a notification or indicator that the battery pack is ready and the battery packs can be connected with the primary pack for discharging operation charged and/or is balanced with the one or more battery packs being discharged (Step 56). The max(Vt) value can be the highest voltage value for a single pack of the system. If the Vt, is not equal to min (Vt) then the system will provide an indication to the user/controller that the system is not ready and one or more battery packs may be unbalanced and/or not ready to be connected for charging or discharging.

Additionally, the system can determine the current limit as shown in FIG. 5 for all battery packs. The current limit calculations can determine how much current the device can take from the battery system 1000 as well as the current measurements for the individual battery packs 200 and the battery pack system collectively. The current limits for the individual battery packs can first be determined and provided to the control system 400 and/or one or more battery pack controllers 300. The controllers 300 can receive one or more measurements for the battery packs and/or individual battery cell, including but not limited to Vt, I, Tint, Him, or the battery temperature for each of the battery packs (Step 61). A vector OCV value can be determined utilizing Formula 1 recited above (Step 63). This OCV measurement can be a vector measurement of the entire battery system including all of the battery packs at any period of time of operation (charging or discharging). The Vtmin and Vtmax can be determined using formulas 2 and 3 respectively (Step 65). The Vtmin can be a vector value for the voltage the battery pack would be at lowest voltage limit. The Vtmax can be a vector value for the voltage of the battery pack would be at highest voltage limit. The packs may have different VTmax and Vtmin values.

Vtmin=min(OCV+Rint*I_{Clim}) Formula 2:

Vtmax=max(OCV+Rint*I_{Dlim}) Formula 3:

Furthermore, the Load Charge Current Limit (It_{c}) and the Load Discharge Current Limit (It_{d}) can be determined and calculated by the system utilizing formula 4 and 5 respectively (Step 67 and 68). These measurements can be calculated and sent out a device to be used by the device for establishing the current limits of the battery packs collectively.

These values can then be communicated back to the control system 400 and/or one or more battery pack controllers 300. In some exemplary embodiments, the values can be stored on a memory. Additionally, the values can further be used by the system to monitor the current limit of all battery packs of the system. These measurements can be used to ensure that the current limit of the battery pack system does not exceed a pre-determined threshold of the device.

$${It}_{C} = {\sum }_{i = 1}^{n} \frac{{V}_{tmin} - {OCV}_{i}}{{R}_{t}} \qquad Formula 4$$

$${It}_{D} = {\sum }_{i = 1}^{n} \frac{{V}_{tmax} - {OCV}_{i}}{{R}_{i}} \qquad Formula 5$$

The method above can determine which current limit is the minimum by comparing the open circuit voltage to the terminal voltage at the respective current limit. A new current limit value can be calculated based upon the comparison. All current information from the battery packs. Current can't be controlled through each battery pack and is a function of open circuit voltage and internal resistance. Each battery pack may have a different internal resistance but same voltage. In some embodiments an individual battery pack can have more current flowing through it than the remaining battery packs. In the present system, the current through the various packs may be different, but can limit discharging and charging at a level that is safe (at a pre-determined threshold) for each of the battery packs. The system can monitor the currents through each battery pack and ensure the device is only receiving a safe level of current for the battery packs. Each battery pack can be communicatively coupled to the master control to provide whether the current is safe to use and can open contactors if a threshold is exceeded.

When the energy storage system 1000 of the present disclosure is being utilized, the control system 400 can measure the voltage of each battery pack 200 simultaneously. During operation, one or more battery packs may be connected to the high voltage bus in order to reduce the voltage difference between the one or more battery packs. The control system 400 can the measure the instantaneous voltage of each battery pack 200 of the energy system. Additionally, the control system can determine an estimated open circuit voltage. The control system can initiate the connection of the battery packs if the measured instantaneous voltage is such that if the contactors were to close an acceptable current would flow when the contactor connects. These threshold values can be monitored and calculated in real time operation of the system. Furthermore, the control system will only permit the one or more battery packs to connect when the difference between the estimated open circuit voltage of the battery packs and all other connected battery packs to the high voltage bus is low enough to limit the balancing current to a calibratable value which can be measured by the control system. The system can additionally estimate contactor life based upon current and switching events. The calibratable voltage threshold can be used to anticipate and optimize system life and prevent fault detection. It can be used to further enhance contactor lifespan as well. The stored values can be used for additional analytics to optimize battery system health, life span, and/or performance.

As previously recited, in one exemplary embodiment the battery management system of the present disclosure can optimize the charging and discharging of one or more battery packs. The control system can sense when a charging apparatus is coupled to the charging port of the system. Based upon the measured values the control system initiates a charging protocol. The control system can use the measured values to determine which battery packs charge relative to the other battery packs. An initial threshold charge limit value can be established for each battery pack. The battery pack with the highest voltage and/or current will be the last battery pack to begin charging. The remaining battery packs can be progressively charged in order of initial charge value until the from lowest to greatest. Once the lowest battery pack reaches the charge value of the next highest battery pack, the system can charge the two battery packs in parallel until the next highest voltage measurement of the next battery pack is reach. Once the final battery pack with the highest initial voltage measurement is reached, all battery packs can charge in parallel until the voltage limit is reached. The system can further initiate a similar process for discharge of battery packs while the battery packs are in a discharge mode.

The system can initiate one or more algorithms or modules in order to monitor the various battery packs. In one exemplary embodiment, the system controller or a single battery pack controller can initiate the startup algorithm/module program to initiate a startup sequence and measurements for each of the battery packs. The startup algorithm can utilize a process described or similar to that disclosed in FIG. 4. Additional modules/programs/algorithms can be initiated as well, such as a module to determine the load current limit for each battery pack and the battery pack system in its totality.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An energy management system comprising:
a first battery pack having one or more battery cells and a second battery pack having one or more battery cells, wherein the first battery pack and the second battery pack are connected in parallel;
a first battery pack controller communicatively coupled to the first battery pack and second battery pack controller communicatively coupled to the second battery pack, wherein the first and second controllers include a processing means, wherein each of the first battery pack controller and second battery pack controller are communicatively coupled to each other at least one of the following:
a voltage sensor, a current senor, or battery temperature sensor.

2. The energy management system of claim 1, further comprising a control system communicatively coupled to the first battery pack and the second battery pack controllers, wherein the control system comprises a processing means and a memory.

3. The energy management system of claim 1, further comprising a third battery pack connected in parallel to the first battery pack and second battery pack, wherein the third battery pack is communicatively coupled to the control system.

4. The energy management system of claim 2, wherein the control system can sense when the system is coupled to a charging port.

5. The energy management system of claim 3, wherein the control system measures the battery current (I), the estimated internal resistance (Rint), and measures the terminal voltage (Vt) of each of the battery packs.

6. The energy management system of claim 4, wherein the system calculates the open circuit voltage (OCV) utilizing the Vt, I, and Rint.

7. The energy management system of claim 6, wherein the first controller or the second controller designates a primary battery pack between one or more of the battery packs, wherein the primary battery pack has a first OCV or Vt threshold value for a first operation.

8. The energy management system of claim 7, wherein the first operation is a charging or discharging cycle.

9. The energy management system of claim 8, wherein the system executes the first operation until the first controller measures a second battery pack having a second threshold value equal to the then current threshold value of the primary battery pack.

10. The energy management system of claim 1, wherein one or more of the battery pack controllers can measure the instantaneous voltage of each battery pack of the energy system.

11. The energy management system of claim 10, wherein one or more of the battery pack controllers can determine an estimated open circuit voltage of each individual battery pack or all of the battery packs.

12. The energy management system of claim 11, wherein one or more of the battery pack controllers can initiate the connection of the one or more battery packs if the measured instantaneous voltage is such that if the contactors were to close an acceptable current would flow when the contactor connects.

13. The energy management system of claim 12, wherein the threshold values can be monitored and calculated in real time operation of the system.

14. The energy management system of claim 13, wherein the current limit of each battery pack can be calculated in real time by each battery pack controller.

15. The energy management system of claim 14, wherein a controller calculates the overall system current limit to ensure that the current limit of each battery pack is within a pre-determined threshold in real time.

16. An energy management system comprising:
a first battery pack having one or more battery cells and a first contactor and a second battery pack having one or more battery cells and a second contactor, wherein the first battery pack and the second battery pack are connected in parallel;
a first battery pack controller communicatively coupled to the first battery pack and second battery pack controller communicatively coupled to the second battery pack, wherein the first battery pack controller and the second battery pack controller include a processing means, a memory and transceiver, wherein each of the first battery pack controller and second battery pack controller are communicatively coupled to each other and at least one of the following:
a voltage sensor, a current senor, or battery temperature sensor; and
wherein first battery pack controller or second battery pack controllers can determine one or more of the following for each of the battery packs:
battery current (I), estimated internal resistance (Rint), terminal voltage (Vt), instantaneous current, charge current limit (I_{Clim}) or the discharge current limit (I_{Dlim}),
wherein the first battery pack controller or second battery pack controllers can then determine the change in terminal voltage (ΔVt) and change in open circuit voltage (ΔOCV).

17. The system of claim 16, wherein the first battery pack controller or second battery pack controllers can further determine when to open or close contactors based upon the measurements of one or more of the following for each of the battery packs: the ΔOCV or ΔVt.

18. The system of claim 16, wherein the first battery pack controller or second battery pack controllers is configured to determine when to open or close the respective battery pack contactors for a charging cycle or discharging cycle of the energy management system based upon the ΔOCV or ΔVt of the first battery pack and the second battery pack.

19. The system of claim 18, wherein each battery pack can further comprise a negative terminal communicatively couped to a discharge switch and the positive terminal can be communicatively coupled to the charge switch; and
a voltage/current sensor configured to measure at least on of the following: the voltage or current the battery pack prior to the charge switch and after the charge switch.
